(19) United States
(12) Patent Application Publication
(10) Pub. No.: US 2024/0278174 A1
(43) Pub. Date: Aug. 22, 2024

(54) USE OF HYDROXIDE IONS AS A HEAT SOURCE

(71) Applicant: EQUINOR ENERGY AS, Stavanger (NO)

(72) Inventors: Gelein DE KOEIJER, Trondheim (NO); Eivind JOHANNESSEN, Trondheim (NO)

(21) Appl. No.: 18/568,606

(22) PCT Filed: Jun. 9, 2022
(86) PCT No.: PCT/NO2022/050132

§ 371 Date: Dec. 8, 2023

(30) Foreign Application Priority Data
Jun. 9, 2021 (GB) 2108256.5

(51) Int. Cl. B01D 53/34; B01D 53/14; B01D 53/62; B01D 53/78; B01D 53/96

(52) U.S. Cl. CPC B01D 53/343; B01D 53/1425; B01D 53/1475; B01D 53/62; B01D 53/78; B01D 53/96; B01D 2251/304; B01D 2251/306; B01D 2251/604; B01D 2252/30

(57) ABSTRACT

The invention provides the use of hydroxide ions as a heat source in a CO₂ absorption process.

### TECHNICAL FIELD

The present invention relates to the use of hydroxide ions as a heat source in a CO₂ absorption process. Specifically, the invention relates to the use of hydroxide ions which have been generated via a process using energy which has not produced CO₂ emissions.

### BACKGROUND OF THE INVENTION

The increasingly serious climate situation caused by large CO₂ emissions from fossil fuel-derived energy production has become a critical societal challenge and has caused serious public concern in recent years. As a result, innovative solutions for CO₂ capture techniques are constantly sought and widely studied.

There are various technologies for reducing CO₂ emissions from small and/or mobile sources (e.g. waste incineration, boilers, industrial turbines, industrial engines, cars, trains, trucks, ships, ferries). Such technologies include the use of: energy carriers that do not produce CO₂ during energy conversion, such as H₂, NH₃ and electricity; battery-combustion hybrids; biofuels; synthetic fuels, including hydrocarbons; and various post-combustion CO₂ capture technologies, including membranes and compact/modularized amine-based post-combustion, rotating absorption/desorption techniques.

However, such existing technologies have significant disadvantages. All existing technologies for reducing CO₂ emissions from small and/or mobile sources are significantly more expensive than using current hydrocarbon fuels in conventional combustion engines. The use of synthetic fuels, H₂, NH₃ and electricity instead of hydrocarbons are not direct CO₂ emission reduction technologies, but only reduce emissions if renewable or carbon capture and storage (CCS) is used for producing them. It is expensive to keep their lifecycle CO₂ emissions very low. The use of electricity requires batteries that are heavy, low capacity/range, and use scarce metals. Battery manufacture can have significant lifecycle CO₂ emissions. H₂/NH₃ fuel cells are heavy and use scarce metals. H₂ and NH₃ have demanding safety issues and are not easily storable in contrast to petrol and diesel. The use of battery-combustion hybrids only partly reduces CO₂ emissions. Biofuels require large land areas for growing the necessary crops. The cheapest fast-growing biofuel crops compete with food, and non-food biofuels are expensive and/or slow growing. Upgrading the biomass to petrol/diesel is energy intensive, has low efficiency, and still results in significant life cycle CO₂ emissions. Current technologies for CO₂ capture from mobile/small sources are relatively heavy and large, and require competent personnel for operating and maintaining. They also have complex emission and discharge issues. Compression/liquefaction/storage of small volumes of CO₂ is relatively expensive, and has safety issues due to the high pressure under which CO₂ is stored.

CO₂ capture by decoupled absorption and desorption is a possible technology for CO₂ emissions reduction from smaller and mobile sources. This technology employs equipment at the CO₂ emission source which is very simple, compact and requires little competence. Furthermore, there are no complex emission/discharge issues and the chemistry involved is often straightforward. It can reduce the threshold for small low manning and competence industries with little space to consider CO₂ capture. Such systems can provide simultaneous:
Competitive CO₂ emission reduction from small and/or mobile sources by having a low weight compact safe and easy to handle system.
Efficient use of cheap energy in future energy systems (electricity from wind/solar, heat from low CO₂ turbines).
Use of existing hydrocarbon infrastructure and competence.
Synergy with conventional water electrolysers and H₂ and O₂ users.

The present inventors have unexpectedly found that hydroxide ions may be employed as a heat source in such processes as well as more generally in any CO₂ absorption process. Surprisingly, the level of heat generated through the use of hydroxide ions is significant and of commercial and economic relevance.

In particular, in a decoupled absorption and desorption process, it is possible to convert renewable energy from the desorption site first into chemical energy in the form of OH⁻ and subsequently release it in the form of heat by the exothermic reaction of OH⁻ with CO₂ in the absorption site. In this way, renewable energy may be transferred from the desorption site to the absorption site, where it can have a larger value. This is especially useful for CO₂ emission sites that already produce low grade heat, like district heating plants. By using hydroxide ions as a heat source, these sites can either increase heat production or decrease fuel demand. In a truck or ship this heat could be used for heating of cargo, driver cabin or deck offices/rooms.

### SUMMARY OF THE INVENTION

In a first aspect, the invention provides the use of hydroxide ions as a heat source in a CO₂ absorption process.

In a particularly preferred embodiment, said CO₂ absorption process is part of a decoupled CO₂ absorption and desorption system.

In a further preferred embodiment, said hydroxide ions are ions which have been generated via a process using energy which has not produced CO₂ emissions

### DETAILED DESCRIPTION OF THE INVENTION

The present invention describes the use of hydroxide ions as a heat source in a CO₂ absorption process.

The hydroxide ions are typically employed in aqueous solution (e.g. water) together with one or more cations. Suitable cations are any wherein the corresponding hydroxide compound is soluble in aqueous solution. By “soluble” in this context we mean a solubility in aqueous solution which is high enough to enable the formation of a homogenous solution. The solubility of the hydroxide compound in water may be at least 1 g/L at ambient temperature (e.g. 18 to 30° C.) and pressure (RTP), preferably at least 2 g/L, more preferably at least 5 g/L. Examples of such cations include potassium (K⁺), sodium (Na⁺) and lithium (Li⁺).

In a preferable embodiment, the hydroxide ions are used at a concentration up to 30 mol %, such as 2 to 30 mol %, more preferably 5 to 20 mol %.

The use of hydroxide ions as a heat source unexpectedly leads to a significant increase in the heat produced from the CO₂ absorption process. The stored chemical energy in the hydroxide ions is converted and released as thermal energy during the CO₂ absorption process. In one aspect of the invention, the heat produced is increased by up to 50%, relative to an identical heat production process wherein hydroxide ions are absent. This degree of heat generation is unprecedented.

Ideally, the hydroxide ions are ones which have been generated via a process using energy which has not produced CO₂ emissions, most preferably renewable energy. In this context, the hydroxide ions can be considered to function as a renewable heat source.

The CO₂ absorption process in which the hydroxide ions are employed may be any suitable process, but is typically one in which the hydroxide ions also participate directly in the absorption process. For example, the absorption process may employ an aqueous hydroxide solution, which is preferably easy to handle, non-volatile, non-degradable, with minimal or no harm to the environment. This solution (which may also be termed the “sorbent” or “lean solvent”) absorbs the CO₂, resulting in the formation of carbonate salts and water. These absorption processes will be well known to those skilled in the art.

The CO₂ absorption process may take place in any suitable apparatus, such as apparatus comprising an absorption column or a membrane contactor. The column may be any suitable column known in the art such as a packed column, a tray column, a falling-film column, a bubble column, a spray tower, a gas-liquid agitated vessel, a plate column, a rotating disc contactor or a Venturi tube. The process may also be carried out in a conventional mixer, for example in a co-current or a counter-current mixer.

Unfortunately some sorbents employed in CO₂ absorption processes do not have favourable kinetics, and especially in mobile sources there is not much space available. In view of this problem, the CO₂ absorption may take place in an enhanced mass transfer device since this is the lightest and smallest option. The enhancement can be done using e.g. rotation, sound, spray, electricity, catalysis, membrane(s) or enzymes. If space and weight constraints are severe, the absorption preferably does not rely only on gravity (falling liquid over a packing) and/or pressure drop (adsorption on solids) alone for bringing CO₂ in contact with the sorbent, because this technique may not capture enough CO₂ and will likely need enhanced mass transfer.

The CO₂ absorption process preferably occurs at as high a temperature as possible, but ideally below 100° C., to keep the water balance in control and avoid expensive cooling and excessive water production from the flue gas. Between 40° C. and 80° C. is preferred.

The CO₂ absorption process is preferably part of a decoupled CO₂ absorption and desorption system. A decoupled CO₂ absorption and desorption system is employed in CO₂ capture processes and involves the use of separate absorption and desorption units. The absorption unit is located at the source of CO₂ to be captured and the desorption unit is located elsewhere.

CO₂ absorption typically occurs as described above. The sorbent, together with absorbed CO₂ (termed herein the “rich solvent”) is then transported to the desorption unit

Desorption is typically performed at a stationary site where cheap energy is available from low CO₂ producing sources, preferably renewable energy sources. Such low CO₂ sources include electricity from wind/solar/CCS/nuclear. The CO₂ desorption is preferably done by electrolysis of the rich solvent, preferably combined with H₂O electrolysis producing useful side-products O₂ and H₂. As an alternative or supplement to electricity, heat can be used for the desorption. The CO₂ which has been desorbed may then be transported for storage. The desorption site also regenerates the lean solvent (i.e. the aqueous hydroxide solvent) which can be recycled back for use as a heat source at the absorption site.

The CO₂ capture system may also serve as a NOx and SOx reduction measure, removing the need for conventional technologies, especially in diesel engines, reducing costs.

An example of a decoupled CO₂ absorption and desorption system is described below, with reference to FIG. 1.

CO₂ is captured from the exhaust of the source apparatus (e.g. vehicle or apparatus) using a compact, lightweight absorption unit. The absorption may be performed using a lean solvent such as KOH and/or NaOH, which is stored in a first tank on the source apparatus, and the resulting rich solvent is stored in a second tank on the source apparatus. The rich solvent may then be transported from the source apparatus, and the CO₂ is desorbed at a stationary facility decoupled from the absorber. Performing only CO₂ capture on the source apparatus (and not the CO₂ desorption) reduces the complexity and weight of the mobile apparatus, and performing desorption at a stationary site where cheap, low-CO₂ energy is available further increases the efficiency of the process. An example of this decoupled CO₂ absorption and desorption system is shown in FIG. 1.

The absorption only is performed at the small and/or mobile CO₂ source, resulting in removal of the CO₂ from a hydrocarbon-based energy conversion unit, without requiring the conventional energy-intensive desorption and CO₂ compression/liquefaction steps at the small/mobile source. This significantly reduces the complexity, size and weight of the apparatus required at the source. Rotating absorbers, membrane contactors or other enhanced mass transfer technologies can reduce the equipment size even more. The CO₂ source needs only an absorber, a tank for fresh solvent and a tank for spent solvent. The solvent can be a solid, slurry or liquid. The solvent can optionally be diluted before use and concentrated after use for reducing the stored and transported volumes (e.g. with reverse osmosis).

The supply/storage system transports lean and rich solvent to and from the absorber site and the desorber site. The system typically includes solvent tanks at both the absorber site and the desorber site. If harmless solvents are chosen, these tanks can be atmospheric, simple and cheap. Transport of the solvent can be done by pipelines, sewers, trucks, trains and ships, depending on what is possible and cost efficient. Optionally, if trucks, trains or ships are chosen, these can also have their own small CO₂ absorber on board, reducing the overall chain emissions.

The sorbent used for CO₂ capture is ideally an aqueous hydroxide solution which is easy to handle, non-volatile, non-degradable, with minimal or no harm to the environment. Preferably, it will have high pH, i.e. with high OH— forming content and rapid reaction with CO₂. Candidates are KOH and/or NaOH that form bicarbonate/carbonates with CO₂. Lithium may also be possible instead of sodium and potassium. Their mixtures may optimize the performance. Optionally, promotors (like enzymes and amines) may be added if they do not increase the absorber complexity and emission/degradation risk significantly.

Desorption is performed at a stationary site where cheap energy is available from low CO₂ sources. Such low CO₂ sources include electricity from wind/solar/CCS/nuclear. The CO₂ desorption is preferably done by electrolysis of the rich solvent, preferably combined with H₂O electrolysis producing useful products O₂ and H₂. There can be synergy with conventional H₂O electrolysis using similar equipment. As an alternative or supplement to electricity, heat can be used for the desorption. This heat can come from gas turbines, boilers, hydrogen/synthesis gas/NH₃ production or (bio-)refineries with CCS. For such heat use, a solvent is needed that desorbs the CO₂ and produces hydroxide upon heating. K₂CO₃, Na₂CO₃, KHCO₃ and NaHCO₃ do not desorb the all of the CO₂, and do not produce KOH/NaOH easily under cheap low temperature heating (<150° C.). So, transferring the CO₂ to another cation may be an option if such cheap heat is to be used. Alternatively, higher heat, and/or more expensive heat may be used. The spent solvent is optionally pressurized prior to desorption for reducing CO₂ compression costs.

A more detailed version of this system is shown in FIG. 2 for a waste incinerator using KOH as solvent. In this system:
KOH dissolved in water is used as a solvent. KOH is a strong solvent, leading to a small and very simple absorber. Because KOH is a salt, no water wash is needed for fugitive emissions to air. Any entrained emissions to air are likely harmless. The KOH reacts to form KHCO₃/K₂CO₃ in the absorber. The rich solvent may become a slurry. To reduce the transport costs, the rich solvent can be concentrated even further using e.g. reverse osmosis. Sodium (Na) or Lithium (Li) and their mixtures can also be considered instead of only Potassium (K).
A KHCO₃/K₂CO₃ solution, slurry or solid is stored in conventional cheap tanks and transported by truck, train, boat and or sewer/pipeline to an electrolysis plant. Preferably, multiple absorber sites transport to one bigger electrolysis site, to provide economy of scale on the desorber and compressor.
The rich solvent KHCO₃/K₂CO₃ is added to an electrolyser with water. O₂ and CO₂ are formed on one side, while H₂ is formed on the other side. The electricity preferably comes from renewable energy, biomass and/or from power plants with CO₂ capture storage. The CO₂ and O₂ are separated. The CO₂ is transported away for permanent geological storage. The 02 may be used for oxyfuel applications. The H₂ is typically used for industry or transport e.g. in ships as fuel or as a chemical for making NH₃. The electrolysis product KOH can be concentrated using e.g. reverse osmosis. An alternative to electrolysis can be the transfer of the carbonate from K to Ca, and a heat and natural gas-based desorption technology may then be used.
The KOH is transported as a solution, slurry or solid and is stored in conventional cheap tanks, and can be transported by truck, train, boat and or sewer/pipeline back to the absorber site.

### DESCRIPTION OF FIGURES

FIG. 1: Example of a decoupled CO₂ absorption and desorption system

FIG. 2: Example of a decoupled CO₂ absorption and desorption system for a waste incinerator using KOH as solvent

FIG. 3: Simplified process flow scheme with main modelling results

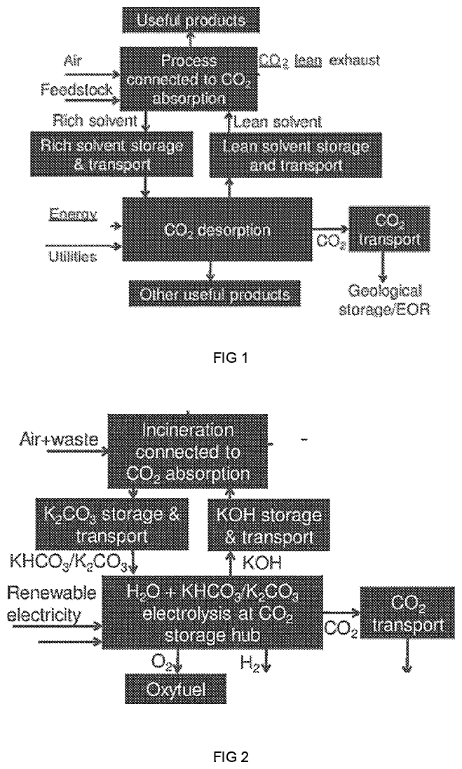

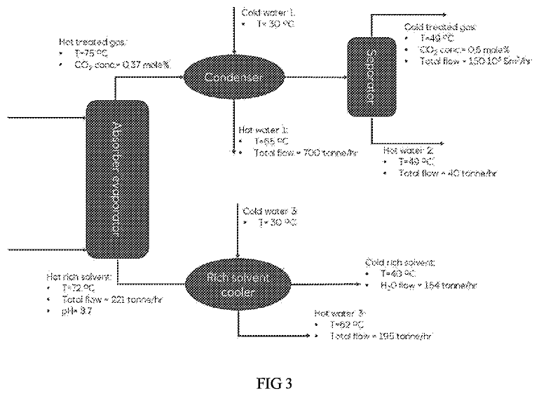

### EXAMPLES

The following simulation data has been obtained to demonstrate the invention.

### Method and System

The system is shown in FIG. 3, which is a simplified process flow scheme with main modelling results. A modelling tool was used with good enough thermodynamic packages for salts that are relevant for NaOH based CO₂ capture (mainly carbonate and bicarbonate). The exhaust is chosen to be the exhaust from a typical steam reformer.

The Table below gives the constant input parameters

| | |
|---|---|
| Flue gas flow (STDm³/hr) | 194000 |
| Flue gas flow (tonne/hr) | 221 |
| Flue gas temperature (° C.) | 200 |
| CO₂ mole fraction in flue gas | 8.57 |
| Lean solvent inlet temperature (° C.) | 30 |
| Rich solvent outlet temperature (° C.) | 40 |
| CO₂ outlet mole fraction | 0.5 |
| Storage volume for period between discharge | 7 |
| of (bi)carbonate and OH⁻ refill (days) | |
| Cold water inlet temperature (° C.) | 30 |
| CO₂ captured (tonns/yr) | 257820 |
| Capture rate (%) | 95 |
| Number of stages in absorber/evaporator | 5 |

The inlet temperature is on purpose chosen high and comes straight and unsaturated from the process. No pressure differences are modelled. The exhaust is not pre-cooled as done in conventional post-combustion capture, which saves equipment and CAPEX. The absorber is therefore also an evaporator. The heat is taken out from the cleaned exhaust, which is saturated with water. So, the cooler after the absorber/evaporator becomes a condenser with a much higher heat transfer coefficient than a similar cooler in the unsaturated CO₂-rich exhaust. So, it is smaller and has lower CAPEX. Moreover, the cleaned exhaust also contains the exothermic heat of reaction of CO₂ and OH⁻ to carbonate/bicarbonate. So, there is also more heat to extract. Most of the low grade heat product is extracted from this condenser. But there is also some low grade extraction from the rich caustic cooler.

The detailed design of this absorber/evaporator and condenser can consist of one or more units. It could be one unit with all functions integrated, or multiple units each one performing one (partial) function. Important for the design is which NaOH concentration is optimal, and how possible precipitation can be handled and controlled. Inspiration can be obtained from SOₓ removal from flue gasses (FGD—flue gas desulphurization) and various drying technologies.

The following 2 cases were simulated in the modelling tool with different NaOH concentrations in the lean solvent entering the absorber evaporator:
“Realistic conservative” with 9 mole % NaOH in lean solvent (see FIG. 3)
“No capture”, only evaporation of water with 0% NaOH in lean solvent, rest same as “Realistic conservative”. By comparing this case with the “Realistic conservative” it is possible to estimate the contribution due to capture.

One shortcoming of the modelling tool is that is does not have precipitation of (bi)carbonate included in the model. So, only cases without precipitation could be modelled as an example, while the invention optionally includes precipitation. The first case with 9 mole % NaOH in the lean solvent is realistic, because the concentrations are low enough for avoiding precipitation.

### Results and Conclusions

The results are given below

| | Realistic | No capture |
|---|---|---|
| NaOH mole in lean solvent % | 9 | 0 |
| Lean solvent flow (tonne/hr) | 211 | 13.7 |
| Lean solvent flow (STDm3/hr) | 190 | 13.7 |
| Lean solvent storage (m3) | 31920 | NA |
| Temperature out of absorber (° C.) | 75.1 | 69.5 |
| Condenser duty (MW) | 28.6 | 24.0 |
| Cond hot water temperature (° C.) | 65.2 | 59.5 |
| Cleaned exhaust temperature (° C.) | 49.5 | 49.1 |
| Slightly acid water production (tonne/hr) | 40.5 | 33.9 |
| Rich solvent cooler duty (MW) | 7.21 | 0 |
| Cooler hot water temperature (° C.) | 61.9 | NA |
| Rich solvent flow (tonne/hr) | 221.7 | 0 |
| Rich solvent flow (STDm3/hr) | 208.2 | NA |
| Rich HCO₃⁻ concentration (mole %) | 3.73 | NA |
| Rich CO₃²⁻ concentration (mole %) | 2.67 | NA |
| Rich solvent storage (m3) | 34977 | NA |
| Sum of heat production (MW) | 35.81 | 24 |
| Total storage volume (m3) | 66897 | NA |
| Storage per tonne captured CO₂ | 12.36 | NA |
| (independent of discharge/refill interval) | | |

The following observations, conclusions and recommendations can be made:
The “Realistic—no precipitation” case extracts 35 MW low grade heat, while the “no capture case” only 24 MW. So, the addition of CO₂ capture to the evaporation increases the heat production with 49%, which comes ultimately from renewable sources. This is evidence of a significant upside of this technology.
For scaling up and down one can use the storage per tonne captured CO₂, which is independent of discharge/refill interval. In the realistic case it is around 12 m³/tonne CO₂. It is expected to decrease with higher NaOH concentration with more precipitation. This value will always be above 2, also if pure or extremely concentrated NaOH (above 90%) is used. The reason is that two tanks are needed and the molar mass of CO₂ is 44 and of NaOH 39 and 1 mole NaOH reacts with one mole CO₂ and needs water. Extremely concentrated NaOH solutions are not likely to be used since they are probably very viscous hindering mass transfer and there will be not enough water for the evaporation and reactions.
The temperature of the produced warm water is modest. This is not high enough for all heating applications and district heating networks (e.g. Trondheim has up to 120° C.), but it can work for some. Alternatively, the heating in the CO₂ capture/evaporator can be used as a pre-heating step. The water can be heated more in a heat recovery system in the exhaust prior to the CO₂ capture/evaporator unit.
The water balance is not closed, but this is highly dependent on inlet and outlet temperatures. These temperatures can be regulated to a certain degree. So, this technology can both produce water and be a water consumer.
The heat from the rich caustic cooler can be used to pre-heat the lean solvent. In most cases this will be a useful heat integration and save CAPEX, but does only move heat production from one heat exchanger to another. The overall conclusions will be the same.

1. Use of hydroxide ions as a heat source in a CO₂ absorption process.

2. The use as claimed in claim 1, wherein the hydroxide ions are in aqueous solution together with one or more cations.

3. The use as claimed in claim 2, wherein the one or more cations are selected from the group consisting of potassium (K⁺), sodium (Na⁺) and lithium (Li⁺).

4. The use as claimed in any of claims 1 to 3, wherein the concentration of hydroxide ions is up to 30 mol %, preferably 2 to 30 mol %, more preferably 5 to 20 mol %.

5. The use as claimed in any of claims 1 to 4, wherein said process produces up to 50% more heat, relative to an identical process wherein hydroxide ions are absent.

6. The use as claimed in any of claims 1 to 5, wherein said hydroxide ions have been generated via a process using energy which has not produced CO₂ emissions, preferably renewable energy.

7. The use as claimed in any of claims 1 to 6, wherein said process employs an aqueous hydroxide solution as a sorbent.

8. The use as claimed in any of claims 1 to 7, wherein said CO₂ absorption process occurs at a temperature below 100° C., preferably 40° C. to 80° C.

9. The use as claimed in any of claims 1 to 8, wherein the CO₂ absorption process is part of a decoupled CO₂ absorption and desorption system.

10. The use as claimed in claim 9, wherein said desorption uses low CO₂ producing energy sources, preferably renewable energy sources.

11. The use as claimed in claim 9 or 10, wherein the desorption generates hydroxide ions, which are recycled back to the absorption process.
